(19) United States
(12) Patent Application Publication
(10) Pub. No.: US 2006/0219746 A1
(43) Pub. Date: Oct. 5, 2006

(54) Vehicle storage box with flat access

(75) Inventors: Tim L. Kniffel, Ortonville, MI (US); Dino Filias, Sterling Heights, MI (US); Andrew Olszewski, Southfield, MI (US); Mark Hickey, Howell, MI (US); Keijo Huotari, Fenton, MI (US)

Correspondence Address: Warn, Hoffmann, Miller & LaLone, P.C., P.O. Box 70098, Rochester Hills, MI, 48307, US

(73) Assignee: Decoma International Inc.

(21) Appl. No.: 11/096,465

(22) Filed: Apr. 1, 2005

(51) Int. Cl. B60R 9/00; A47B 37/00; A47B 23/00; B60R 7/00

(52) U.S. Cl. 224/404; 108/44

(57) ABSTRACT

A vehicle storage/cargo box system is provided. The system includes at least one access portion, such as but not limited to a door member, for providing access to the interior of a box portion. The box portion includes a weather stripping and door arrangement that allows flat access to the load floor of the box portion. The load floor of the box portion is above the level of the access door's weather stripping flange portion. The system includes various additional access portions, including but not limited to multiple door configurations that articulate in several different manners. The system also includes various storage and support devices such as but not limited to drawers, shelves, tables, and/or the like.

### FIELD OF THE INVENTION

The present invention relates generally to storage boxes for vehicles, and more particularly to storage boxes for vehicles that provide multiple access portions and substantially flat surfaces for loading cargo into and unloading cargo out of the box portion.

### BACKGROUND OF THE INVENTION

Vehicle storage boxes, particularly those that are used in the bed of pickup trucks or other vehicles, typically have one or more top access doors. Because of the height of most of these types of vehicles, access to the floor of the box is somewhat limited.

Recently, side access vehicle storage boxes have seen more frequent use. In such boxes, e.g., for passenger vehicles, there remains difficulty in gaining access to the load floor. In these prior constructions, the door shut face typically has a flange for mounting the weather stripping (e.g., for preventing the ingress of water into the box) and reacts against the door which is typically higher than the load floor. Because of this arrangement, loading cargo into the box and/or removing cargo from the box frequently damages the flange and/or the weather stripping or even the cargo itself. Cargo also requires lifting up and/or out to avoid these obstacles as opposed to allowing direct sliding of cargo out of the box.

Therefore, there remains a need in the art for a storage box system that allows, among other things, improved access to the interior of the storage box, especially the load floor, while not sacrificing either structural integrity or water management performance.

### SUMMARY OF THE INVENTION

It is an object of the present invention to provide a new and improved vehicle storage box system that obviates at least one disadvantage of the prior art.

In accordance with the general teachings of the present invention there is provided a vehicle storage box having multiple access portions. More specifically, the vehicle storage box of the present invention provides a side access portion, allowing access to a load floor provided in the box. Additionally, the present invention provides a vehicle storage box that also permits access from the top and rear portions of the box, as well as providing storage and support devices such as but not limited to drawers, shelves, tables, and/or the like. The access portions can be articulated in a number of directions and manners, such as lifting, swinging, sliding, and/or the like. In accordance with another aspect of the present invention, a weather stripping flange is provided that is adjacent to, but lower than, the load floor. This aspect provides the ability to the operator to relatively easily store and remove cargo from the load floor without contacting the weather stripping flange.

In accordance with a first embodiment of the present invention, a storage box system for a vehicle, is provided, comprising: (1) a box portion; (2) a load floor portion located within the box portion operable to support a load placed thereon; and (3) a flange portion formed on a surface of box portion, wherein the flange portion is located below the load floor portion.

In accordance with a second embodiment of the present invention, a storage box system for a vehicle, is provided, comprising: (1) a box portion; (2) a load floor portion located within the box portion operable to support a load placed thereon; (3) a flange portion formed on a surface of box portion, wherein the flange portion is located below the load floor portion; and (4) a door portion in operable association with a surface of the box portion.

In accordance with a third embodiment of the present invention, a storage box system for a vehicle, is provided, comprising: (1) a box portion located on a surface of a vehicle; (2) a load floor portion located within the box portion operable to support a load placed thereon; (3) a flange portion formed on a surface of box portion, wherein the flange portion is located below the load floor portion; and (4) a door portion in operable association with a surface of the box portion, wherein the surface of the box portion is selected from the group consisting of a top surface portion, a side surface portion, a rear surface portion, and combinations thereof, wherein the door portion is operable to swing in a mode of movement selected from the group consisting of horizontally relative to the box portion, vertically relative to the box portion, slidingly along a surface of the box portion, and combinations thereof.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a partial perspective view of a vehicle including a storage box system, in accordance with the general teachings of the present invention;

FIG. 2 illustrates a perspective view of a vehicle storage box system having flat access with a hinged door member, in accordance with a first embodiment of the present invention;

FIG. 3 illustrates a partial cut-away view of the vehicle storage box system depicted in FIG. 2, wherein a flange portion for door sealing is lowered below the level of the load floor for ease of cargo loading and unloading and prevention of damage to cargo and seal flange during cargo loading and unloading, in accordance with a first embodiment of the present invention;

FIG. 4 illustrates a perspective view of a vehicle storage box system having flat access with a hinged door member, wherein the load floor is provided with a kick down area, in accordance with a second embodiment of the present invention;

FIG. 5 illustrates a partial cut-away view of the vehicle storage box system depicted in FIG. 4, wherein a flange portion for door sealing is lowered below the level of the load floor for ease of cargo loading and unloading and prevention of damage to cargo and seal flange during cargo loading and unloading, in accordance with a second embodiment of the present invention;

FIG. 6 illustrates a partial perspective of a vehicle storage box system having flat access including a side opening door portion, in accordance with a third embodiment of the present invention;

FIG. 7 illustrates a partial perspective of a vehicle storage box system having flat access including a top opening door portion, in accordance with a fourth embodiment of the present invention;

FIG. 8 illustrates a partial perspective of a vehicle storage box system having flat access including a bottom opening door portion, in accordance with a fifth embodiment of the present invention;

FIG. 9 illustrates a partial perspective of a vehicle storage box system having flat access including a sliding door portion, in accordance with a sixth embodiment of the present invention;

FIG. 10 illustrates a partial perspective of a vehicle storage box system having flat access including a sliding table portion shown in the stowed position, in accordance with a seventh embodiment of the present invention;

FIG. 11 illustrates a partial perspective of the vehicle storage box system depicted in FIG. 10, wherein the sliding table portion is shown in the deployed position, in accordance with a seventh embodiment of the present invention;

FIG. 12 illustrates a perspective of a vehicle storage box system having flat access including additional storage areas in the kick down area, in accordance with an eighth embodiment of the present invention; and

FIG. 13 illustrates a perspective of a vehicle storage box system having flat access including additional storage areas in a raised top portion of the box portion, in accordance with a ninth embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

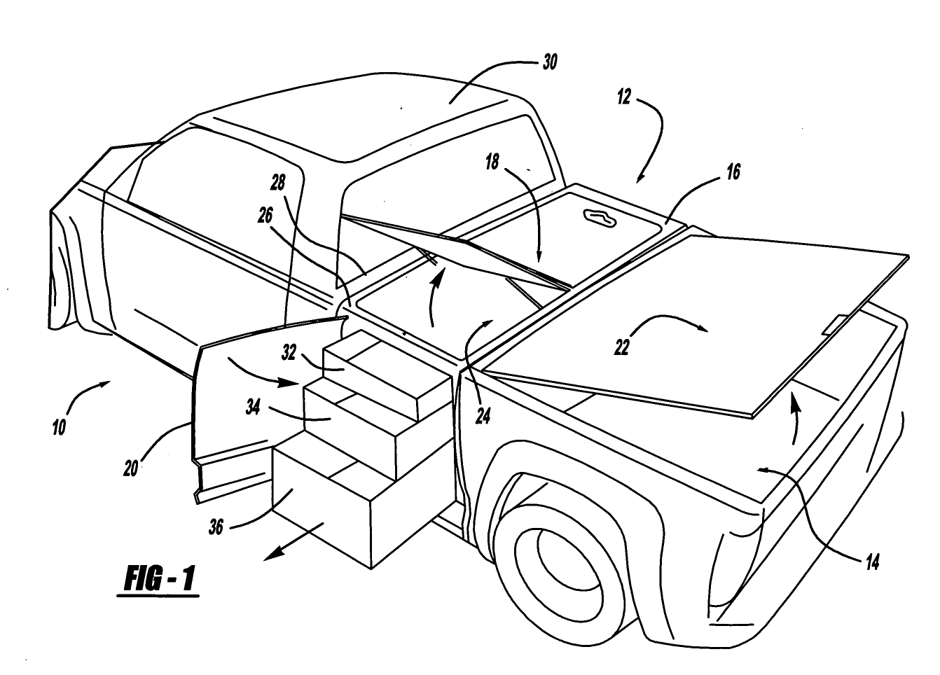

Referring to FIG. 1, there is shown a partial perspective view of a vehicle 10 including a storage box system 12, in accordance with the general teachings of the present invention. System 12 is intended to be located in the bed portion 14 of vehicle 10, although system 12 is operable to be disposed or located in any number of locations relative to vehicle 10. Although a pickup type vehicle is shown, it should be appreciated that system 12 can be incorporated into any number of different types of vehicles.

System 12 includes a box portion 16 defined by a plurality of wall and/or door portions, including but not limited to top door portion 18, side door portion 20, and rear door portion 22, that when properly articulated (e.g., lifted, swung (e.g., vertically, horizontally, and/or the like), slid, and/or the like), permit access to a load floor portion 24 that is operable to accept a cargo load thereon. An optional rear wall portion 26 can also be provided. Alternatively, a rear surface 28 of the cab portion 30 can serve as the rear wall of box portion 16.

In this view, optional drawer members (e.g., of varying size) 32, 34, 36, respectively, can be incorporated into system 12 so as to provide additional storage space and organization to any contents contained within box portion 16. Drawer members 32, 34, 36, respectively, can be accessed in any number of ways and from any number of directions. By way of a non-limiting example, drawer members 32, 34, 36, respectively, can be mounted on roller bearing track systems (not shown) for easy sliding purposes.

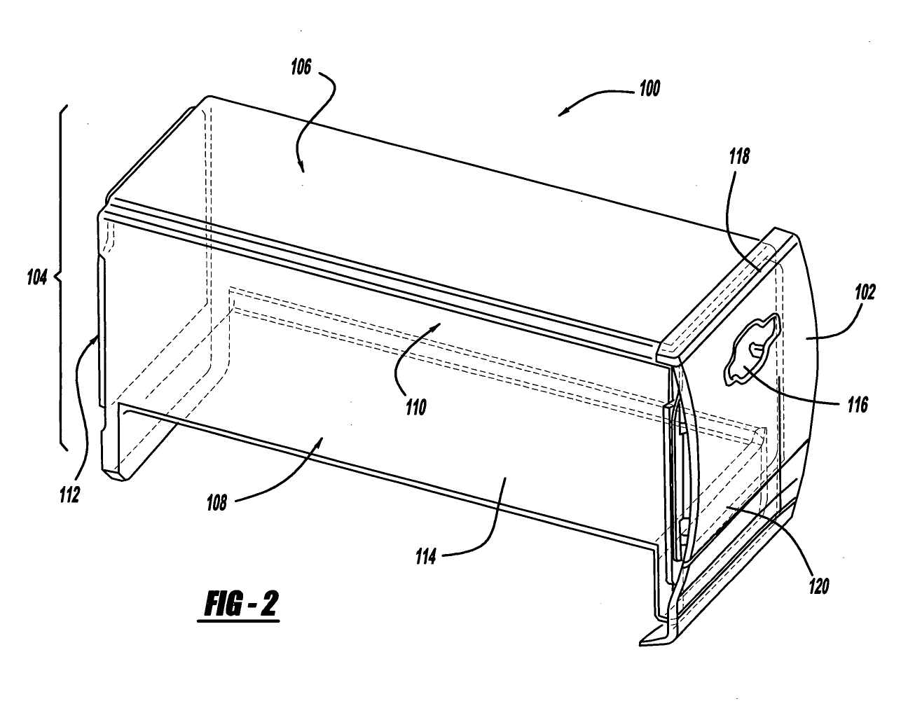

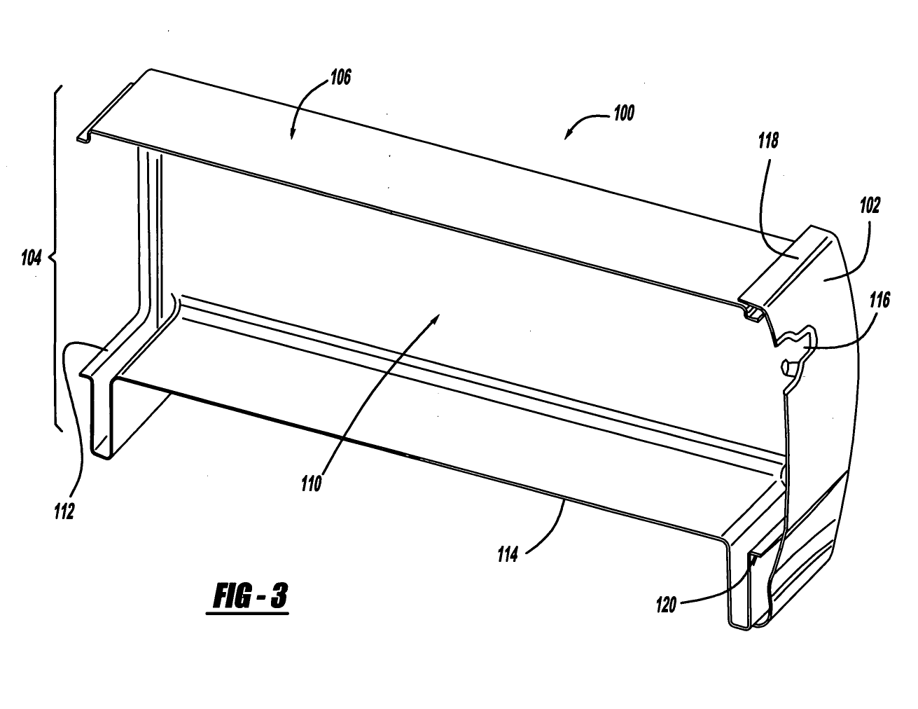

Referring to FIGS. 2 and 3, there is shown a vehicle storage box system 100 having flat access with a hinged door member 102, in accordance with a first embodiment of the present invention. Although only one door member is shown, it should be appreciated that additional door members can be provided in association with system 100. =p System 100 includes a box portion 104 that includes a top wall portion 106, a front wall portion 108, an optional rear wall portion 110, a side wall portion 112, and a load floor portion 114. As previously described, load floor portion 114 is operable to support a cargo load placed thereon.

Door member 102 can be contoured so as to be compatible with a vehicle's exterior contouring. Additionally, door member 102 can be provided with an optional handle member 116 to aid in manipulating door member 102. A hinge system 118 can be provided to allow the door member to pivot, swing, slide, or otherwise move, relative to one of more of the wall portions of system 100.

By “hinge” as that term is used herein, it is meant any device or mechanism that permits movement of the door member relative to the box portion or any other portion of the vehicle storage box system, regardless of direction. By way of a non-limiting example, devices and mechanisms such as but not limited to hinges, springs, grooves, tracks, mortises, tenons, and/or the like can be employed in the present invention.

By way of a non-limiting example, hinge system 118 is in operable association with top wall portion 106 so as to permit door member 102 to move in an upwardly swinging manner. However, it should be appreciated that hinge system 118 can be associated with any of the aforementioned wall portions of system 100.

Referring specifically to FIG. 3, there is shown a partial cut-away view of system 100 depicted in FIG. 2, wherein a flange portion 120 for door sealing is lowered below the level of load floor portion 114. Flange portion 120 is in operable association with a weather stripping portion (not shown), e.g., to provide a sealing function so as to prevent the ingress of water into box portion 104. Flange portion 120 is lower than load floor portion 114 for the intended purpose of ease of cargo loading and unloading and prevention of damage to the cargo and either flange portion 120 and/or the weather stripping portion, e.g., during cargo loading and unloading. That is, the height of flange portion 120 is lower than the height of load floor portion 114.

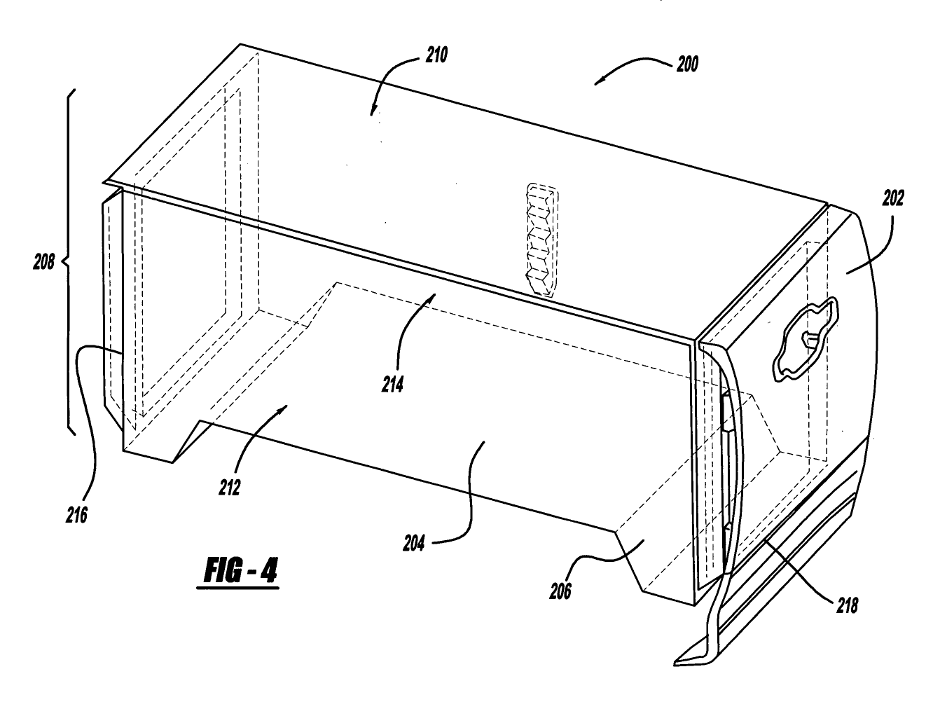

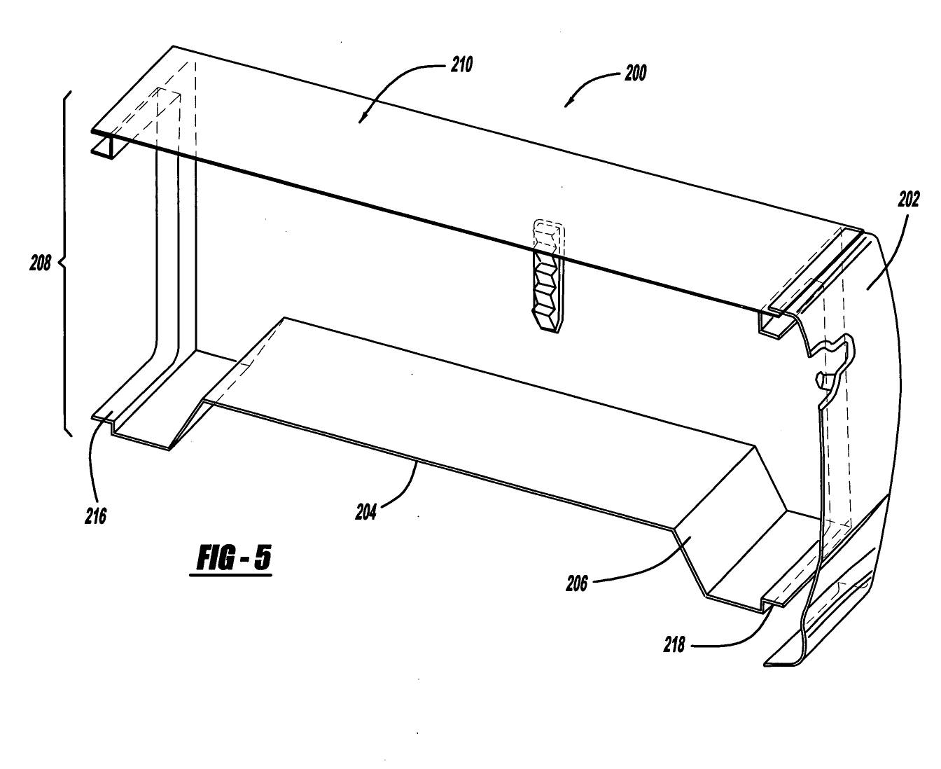

Referring to FIGS. 4 and 5, there is shown a perspective view of a vehicle storage box system 200 having flat access with a hinged door member 202, wherein a load floor portion 204 is provided with a kick down area 206, in accordance with a second embodiment of the present invention. System 200 is similar to system 100 depicted in FIGS. 2 and 3. Although only one door member is shown, it should be appreciated that additional door members can be provided in association with system 200.

System 200 includes a box portion 208 that includes a top wall portion 210, a front wall portion 212, an optional rear wall portion 214, and a side wall portion 216. As previously described, load floor portion 204 is operable to support a cargo load placed thereon.

Referring specifically to FIG. 5, there is shown a partial cut-away view of system 200 depicted in FIG. 4, wherein a flange portion 218 for door sealing is lowered below the level of load floor portion 204. Flange portion 218 is in operable association with a weather stripping portion (not shown), e.g., to provide a sealing function so as to prevent the ingress of water into box portion 208. Flange portion 218 is lower than load floor portion 204 for the intended purpose of ease of cargo loading and unloading and prevention of damage to the cargo and either flange portion 218 and/or the weather stripping portion, e.g., during cargo loading and unloading. That is, the height of flange portion 218 is lower than the height of load floor portion 204.

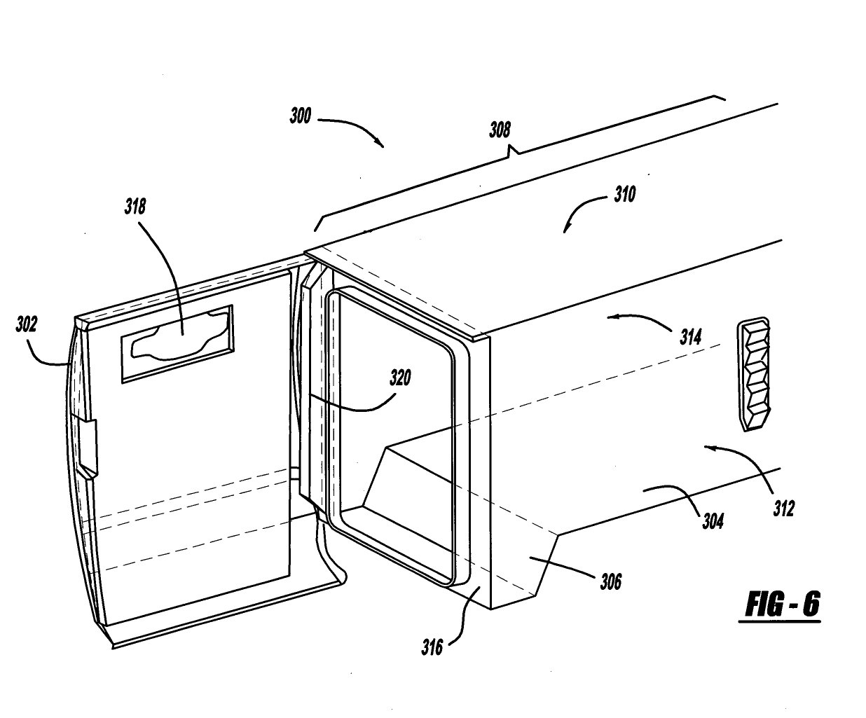

Referring to FIG. 6, there is shown a partial perspective of a vehicle storage box system 300 having flat access including a side opening door member 302, in accordance with a third embodiment of the present invention. System 300 is similar to system 200 depicted in FIGS. 4 and 5, wherein a load floor portion 304 is provided with a kick down area 306. Although only one door member is shown, it should be appreciated that additional door members can be provided in association with system 300.

System 300 includes a box portion 308 that includes a top wall portion 310, a front wall portion 312, an optional rear wall portion 314, and a side wall portion 316. As previously described, load floor portion 304 is operable to support a cargo load placed thereon.

Door member 302 can be contoured so as to be compatible with a vehicle's exterior contouring. Additionally, door member 302 can be provided with an optional handle member 318 to aid in manipulating door member 302. A hinge system 320 can be provided to allow the door member to pivot, swing, slide, or otherwise move, relative to one of more of the wall portions of system 300. By way of a non-limiting example, hinge system 320 is in operable association with optional rear wall portion 314 so as to permit door member 302 to move in a lateral or sideways swinging manner. It should be appreciated that hinge system 320 can be associated with any of the aforementioned wall portions of system 300.

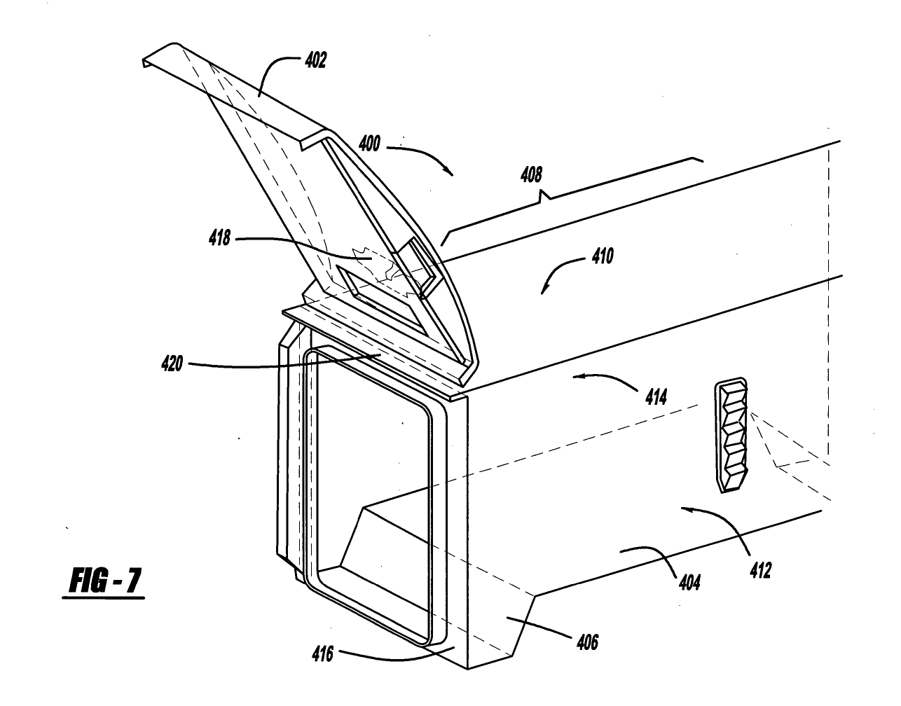

Referring to FIG. 7, there is shown a partial perspective of a vehicle storage box system 400 having flat access including a top opening door portion 402, in accordance with a fourth embodiment of the present invention. System 400 is similar to system 300 depicted in FIG. 6, wherein a load floor portion 404 is provided with a kick down area 406. Although only one door member is shown, it should be appreciated that additional door members can be provided in association with system 400.

System 400 includes a box portion 408 that includes a top wall portion 410, a front wall portion 412, an optional rear wall portion 414, and a side wall portion 416. As previously described, load floor portion 404 is operable to support a cargo load placed thereon.

Door member 402 can be contoured so as to be compatible with a vehicle's exterior contouring. Additionally, door member 402 can be provided with an optional handle member 418 to aid in manipulating door member 402. A hinge system 420 can be provided to allow the door member to pivot, swing, slide, or otherwise move, relative to one of more of the wall portions of system 400. By way of a non-limiting example, hinge system 420 is in operable association with top wall portion 410 so as to permit door member 402 to move in an upwardly swinging manner. However, it should be appreciated that hinge system 420 can be associated with any of the aforementioned wall portions of system 400.

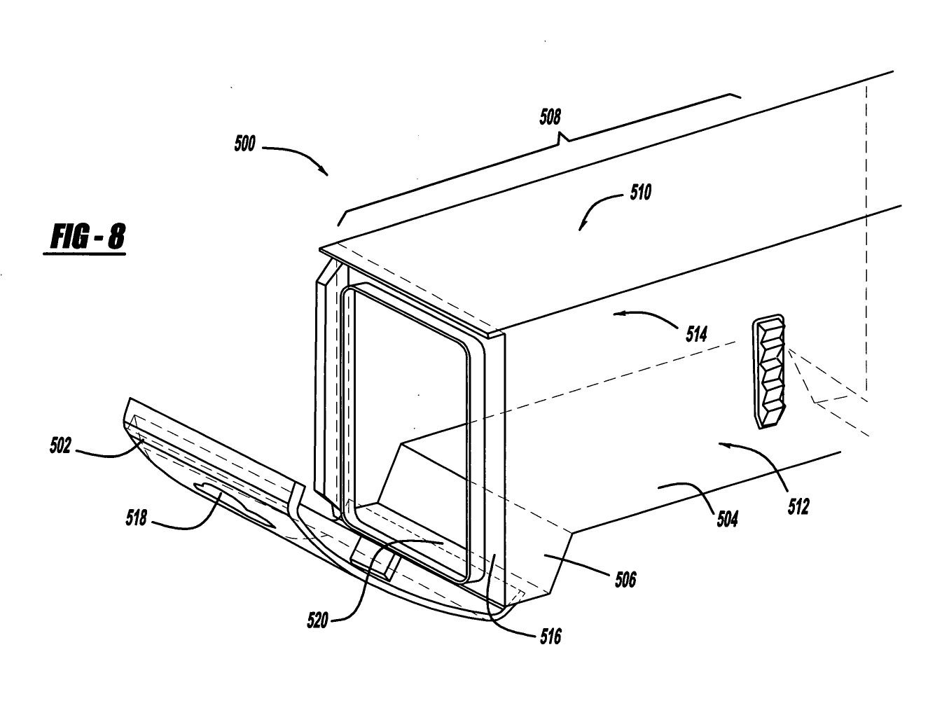

Referring to FIG. 8, there is shown a partial perspective of a vehicle storage box system 500 having flat access including a bottom opening door portion 502, in accordance with a fifth embodiment of the present invention. System 500 is similar to system 400 depicted in FIG. 7, wherein a load floor portion 504 is provided with a kick down area 506. Although only one door member is shown, it should be appreciated that additional door members can be provided in association with system 500.

System 500 includes a box portion 508 that includes a top wall portion 510, a front wall portion 512, an optional rear wall portion 514, and a side wall portion 516. As previously described, load floor portion 504 is operable to support a cargo load placed thereon.

Door member 502 can be contoured so as to be compatible with a vehicle's exterior contouring. Additionally, door member 502 can be provided with an optional handle member 518 to aid in manipulating door member 502. A hinge system 520 can be provided to allow the door member to pivot, swing, slide, or otherwise move, relative to one of more of the wall portions of system 500. By way of a non-limiting example, hinge system 520 is in operable association with kick down area 506 so as to permit door member 502 to move in a downwardly swinging manner. That is, door member 502 is operable to swing in the opposite direction of door member 402 depicted in FIG. 7. It should be appreciated that hinge system 520 can be associated with any of the aforementioned wall portions of system 500.

By allowing door member 502 to move in the manner described, door member 502 can be used as an assist step to access highly placed or stowed cargo. Additionally, door member 502 can also function as a ramp to permit easier ingress/egress to box portion 508 for handling heavy or awkward cargo.

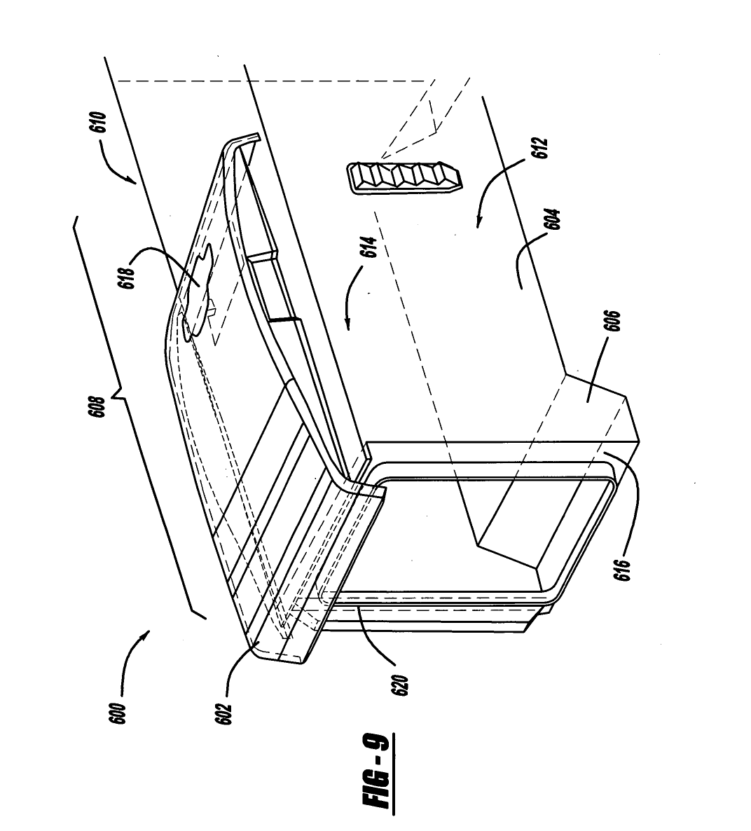

Referring to FIG. 9, there is show a partial perspective of a vehicle storage box system 600 having flat access including a sliding door portion 602, in accordance with a sixth embodiment of the present invention. System 600 is similar to system 500 depicted in FIG. 8, wherein a load floor portion 604 is provided with a kick down area 606. Although only one door member is shown, it should be appreciated that additional door members can be provided in association with system 600.

System 600 includes a box portion 608 that includes a top wall portion 610, a front wall portion 612, an optional rear wall portion 614, and a side wall portion 616. As previously described, load floor portion 604 is operable to support a cargo load placed thereon.

Door member 602 can be contoured so as to be compatible with a vehicle's exterior contouring. Additionally, door member 602 can be provided with an optional handle member 618 to aid in manipulating door member 602. A hinge system 620 can be provided to allow the door member to pivot, swing, slide, or otherwise move, relative to one of more of the wall portions of system 600. By way of a non-limiting example, hinge system 620 is in operable association with front wall portion 612, optional rear wall portion 616, or both, so as to permit door member 602 to slide in an up and down manner. By way of a non-limiting example, hinge system 620 can include at least one spring member that allows door member 602 to slide or glide upwardly (e.g., along track or groove members formed on or in front wall portion 612, optional rear wall portion 616, or both) such that door member 602 can be positioned (e.g., temporarily) on top wall portion 610 in order to allow access to the contents of box portion 608. It should be appreciated that hinge system 620 can be associated with any of the aforementioned wall portions of system 600.

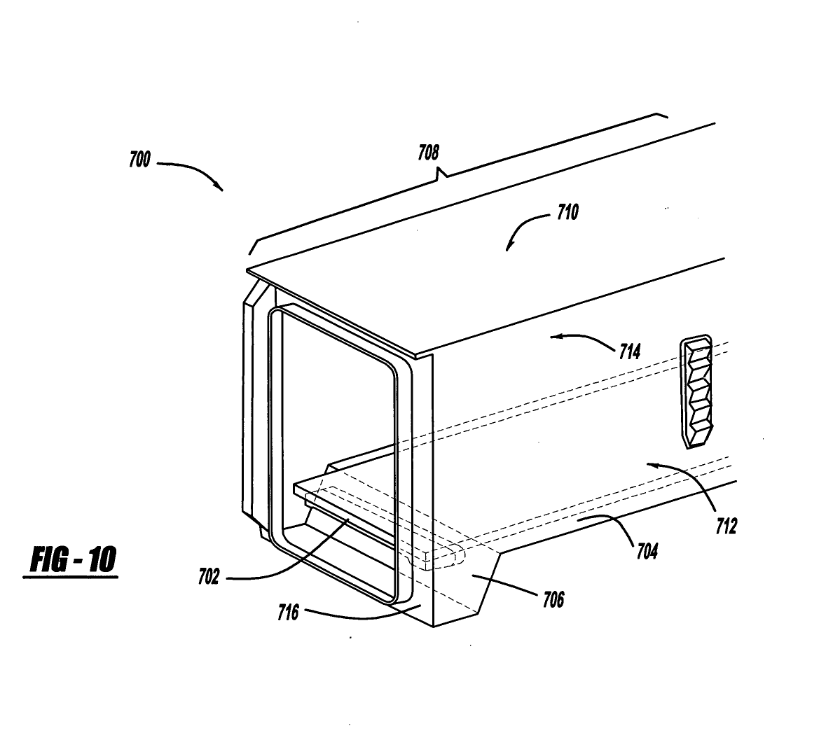

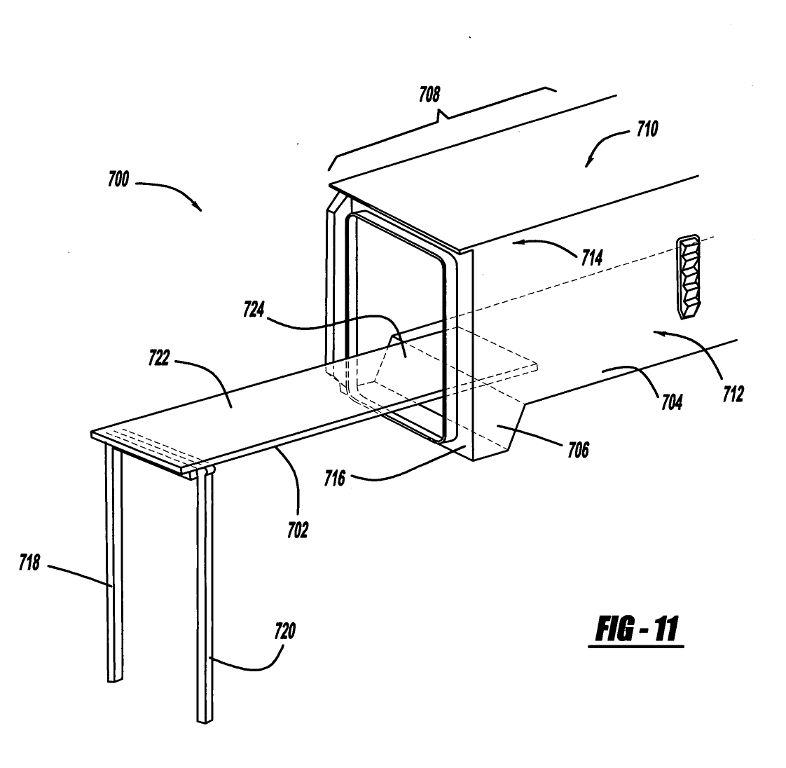

Referring to FIGS. 10 and 11, there is shown a vehicle storage box system 700 having flat access including a sliding table portion 702, in accordance with a seventh embodiment of the present invention. The door member is not shown for purposes of clarity; however, it would normally be associated with one of the wall portions previously described. System 700 is similar to system 600 depicted in FIG. 9, wherein a load floor portion 704 is provided with a kick down area 706.

System 700 includes a box portion 708 that includes a top wall portion 710, a front wall portion 712, an optional rear wall portion 714, and a side wall portion 716. As previously described, load floor portion 704 is operable to support a cargo load placed thereon.

Referring specifically to FIG. 10, table portion 702 is shown in the stowed position, i.e., it is recessed in box portion 708 in proximity to load floor portion 704. Referring specifically, to FIG. 11, table portion 702 is shown in the deployed position, i.e., it is pulled outwardly from box portion 708. A pair of optional leg members 718, 720, respectively, can be selectively deployed to provide support for any loads placed upon the top surface 722 of table portion 702. Table portion 702 can be associated with a track or roller system 724 that permits table portion 702 to be easily and quickly deployed and/or stowed.

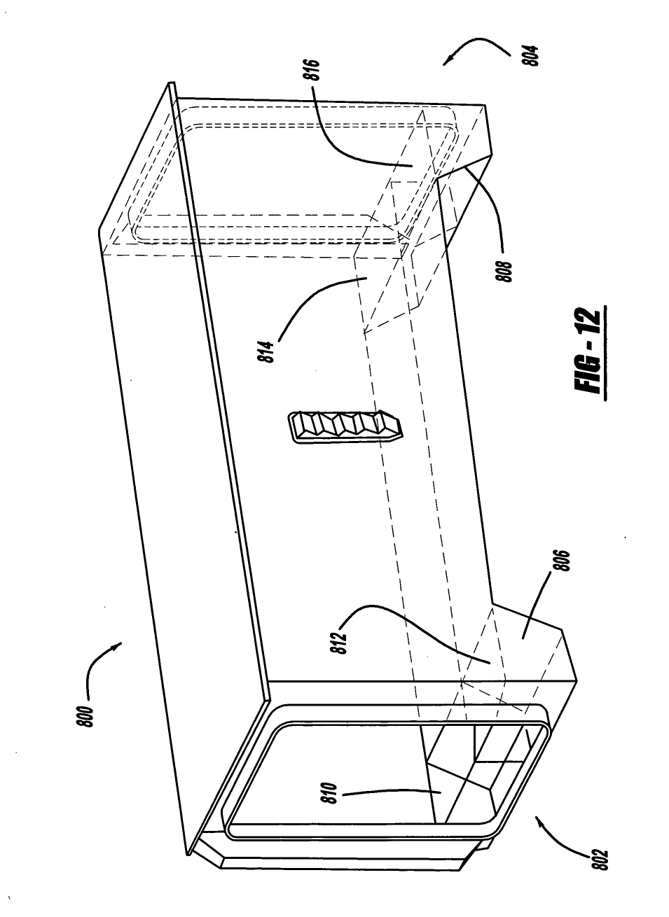

Referring to FIG. 12, there is shown a perspective of a vehicle storage box system 800 having flat access including additional storage areas 802, 804, respectively, in the kick down areas 806, 808, respectively, in accordance with an eighth embodiment of the present invention. Although several storage portions 810, 812, 814, 816, respectively, are shown, it should appreciated that either less than or more than this number can be employed in the practice of the present invention. Furthermore, only one of kick down areas 806, 808, respectively, can include additional storage areas 802, 804, respectively, as opposed to both sides, if so desired.

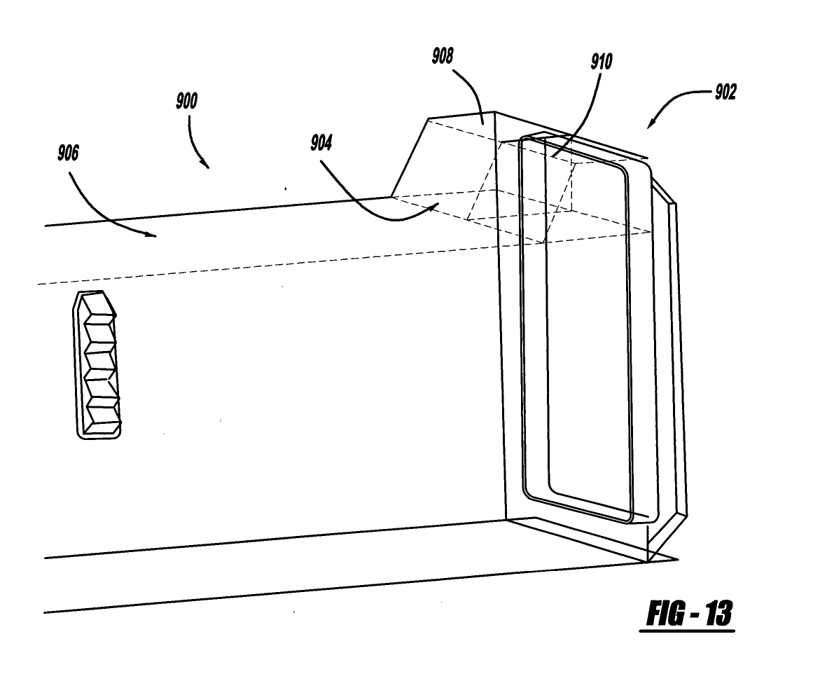

Referring to FIG. 13, there is shown a perspective of a vehicle storage box system 900 having flat access including an additional storage area 902 in a raised top wall portion 904 of the box portion 906, in accordance with a ninth embodiment of the present invention. Although several storage portions 908, 910, respectively, are shown, it should appreciated that either less than or more than this number can be employed in the practice of the present invention. Furthermore, although only one additional storage area is shown, additional storage areas can be provided as well, e.g., on the opposite side of top wall portion 904, if so desired.

Any of the previously described door members can be equipped with optional locking systems (e.g., latch, clasp, hook mechanisms, and/or the like) to secure the door members to their adjacent or abutting wall portions, so as to prevent unauthorized access to the contents of the box portions.

It should be appreciated that any of the aforementioned features of the previously described embodiments can be combined together in any number of combinations and are not limited to use with the specific embodiments in which they were initially described or discussed.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vehicle storage box system, comprising:
a box portion;
a load floor portion located within the box portion operable to support a load placed thereon; and
a flange portion formed on a surface of box portion, wherein the flange portion is located below the load floor portion.

2. The invention according to claim 1, further comprising a door portion in operable association with a surface of the box portion.

3. The invention according to claim 2, wherein the door portion is in operable association with a top surface portion of the box portion.

4. The invention according to claim 2, wherein the door portion is in operable association with a side surface portion of the box portion.

5. The invention according to claim 2, wherein the door portion is in operable association with a rear surface portion of the box portion.

6. The invention according to claim 2, wherein the door portion is operable to swing horizontally relative to the box portion.

7. The invention according to claim 2, wherein the door portion is operable to swing vertically relative to the box portion.

8. The invention according to claim 2, wherein the door portion is operable to slide along a surface of the box portion.

9. The invention according to claim 1, further comprising a support or storage member operably associated with the box portion.

10. The invention according to claim 9, wherein the support or storage member is selected from the group consisting of table, drawers, shelves, and combinations thereof.

11. The invention according to claim 1, wherein the storage box system is operably associated with a vehicle.

12. A vehicle storage box system, comprising:
a box portion;
a load floor portion located within the box portion operable to support a load placed thereon;
a flange portion formed on a surface of box portion, wherein the flange portion is located below the load floor portion; and
a door portion in operable association with a surface of the box portion.

13. The invention according to claim 12, wherein the door portion is in operable association with a surface selected from the group consisting of a top surface portion of the box portion, a side surface portion of the box portion, a rear surface portion of the box portion, and combinations thereof.

14. The invention according to claim 12, wherein the door portion is operable to swing in a mode of movement selected from the group consisting of horizontally relative to the box portion, vertically relative to the box portion, slidingly along a surface of the box portion, and combinations thereof.

15. The invention according to claim 12, further comprising a support or storage member operably associated with the box portion.

16. The invention according to claim 15, wherein the support or storage member is selected from the group consisting of table, drawers, shelves, and combinations thereof.

17. The invention according to claim 12, wherein the storage box system is operably associated with a vehicle.

18. A vehicle storage box system, comprising:
a box portion located on a surface of a vehicle;
a load floor portion located within the box portion operable to support a load placed thereon;
a flange portion formed on a surface of box portion, wherein the flange portion is located below the load floor portion; and
a door portion in operable association with a surface of the box portion;
wherein the surface of the box portion is selected from the group consisting of a top surface portion, a side surface portion, a rear surface portion, and combinations thereof;
wherein the door portion is operable to swing in a mode of movement selected from the group consisting of horizontally relative to the box portion, vertically relative to the box portion, slidingly along a surface of the box portion, and combinations thereof.

19. The invention according to claim 18, further comprising a support or storage member operably associated with the box portion.

20. The invention according to claim 19, wherein the support or storage member is selected from the group consisting of table, drawers, shelves, and combinations thereof.
